(19) United States
(12) Patent Application Publication
(10) Pub. No.: US 2024/0254718 A1
(43) Pub. Date: Aug. 1, 2024

(54) Systems and Methods for Using Discarded Asphalt Shingles (DAS) for Fill Replacement and for Structural Members in Building and Surface Constructions

(71) Applicant: Shingle Waste Solutions, Inc., San Antonio, TX (US)

(72) Inventors: Kurtney KNIGHT, Poteet, TX (US); James EPP, San Antonio, TX (US); Jerauld MORELL, San Antonio, TX (US); Philip KING, Castroville, TX (US)

(21) Appl. No.: 18/433,678

(22) Filed: Feb. 6, 2024

Related U.S. Application Data
(63) Continuation-in-part of application No. 17/858,940, filed on Jul. 6, 2022, now Pat. No. 11,891,769.

(51) Int. Cl. E02D 31/02; C04B 28/00; C04B 111/00; E02D 19/22

(52) U.S. Cl. CPC E02D 31/02; C04B 28/001; E02D 19/22; C04B 2111/00732; E02D 2250/0023; E02D 2300/0006; E02D 2300/0026; E02D 2300/0079

(57) ABSTRACT

Systems and methods are provided for repurposing discarded asphalt shingles as fill material or structural members in building and land surface constructions. Discarded asphalt shingles (DAS) are placed beneath building foundation slabs and parking lots in overlapping patterns to replace a measured amount of removed soil to serve as fill material. Building block system (BBS) units or repurposed asphalt blocks (RAB), may be produced to facilitate handling and transport of the DAS materials to the construction site. DAS can be utilized beneath parking lots by layering the shingles in overlapping patterns to create a moisture barrier from water intrusion from above or below. Repurposed asphalt materials may further be used in the construction of other types of embankments and ground surface constructions to provide both vertical and horizontal support.

### CROSS REFERENCES TO RELATED APPLICATIONS

This Application claims the benefit under Title 35 United States Code § 120 as a Continuation-in-Part of co-pending U.S. patent application Ser. No. 17/858,940, filed Jul. 6, 2022, which in turn claims the benefit under Title 35 United States Code §119(e) of U.S. Provisional Patent Application Ser. No. 63/218,520; Filed: Jul. 6, 2021; the full disclosures of which are incorporated herein by reference.

### BACKGROUND OF THE INVENTION

### 1. Field of the Invention

The present invention relates generally to surface and sub-surface construction methods. The present invention also relates to the recycling and re-purposing of construction materials. The present invention relates more specifically to systems and methods for re-purposing discarded asphalt shingles (hereinbelow also referred to as “DAS”) as fill material and in the form of structural members within and beneath land surface construction (hereinbelow referred to as “LSC”).

### 2. Description of the Related Art

The present invention addresses two specific problems: first, the common need to replace or add soils in and under LSC sites; and second, the interest in keeping discarded asphalt roofing shingles out of landfills.

The present invention seeks to provide a solution to the problem caused by the routine disposal of asphalt shingles in landfills. Eleven million tons of asphalt shingle waste are generated each year most of which ends up in landfills. The disposed asphalt shingles have structural integrity and composition which takes up to 300 years or more to degrade. There is a need for utilization of DAS with significant remaining beneficial usefulness rather than disposal in landfills.

The present invention also seeks to provide an alternative solution to problems associated with building on expansive clay soils that exist in many parts of the country. In significant areas of Texas, for example, there exists strata of expansive soils (also known as swelling clay) near the surface. When located beneath an area designated for LSC, the expansive soil creates an instability for building slabs, drive areas, and parking lots. When subsurface expansive soils are exposed to moisture they expand and create a vertical rise that can cause damage to buildings, drive areas, and parking lots if not addressed. Currently, expansive soils are treated with chemical stabilizers, or the swelling clay is removed and replaced with select fill material which has minimal expansion when exposed to moisture. The cost of select fill is significantly more expensive than DAS. The shingles are placed to form a stable construction pad for LSC.

Moisture around buildings, roadways, and parking lots can migrate below the surface causing damage. Layers of DAS create a moisture barrier that limits the amount of water that impacts surface structures.

### SUMMARY OF THE INVENTION

The present invention provides systems and methods for re-purposing DAS as a replacement for fill material in LSC. DAS, formed into a building block system (herein referred to as “BBS”) is used to replace traditional fill material to establish grade. The depth of DAS will depend on the grade requirements and type of soils encountered. Also, DAS can be utilized beneath parking lots by layering the shingles, whole or partial, in overlapping patterns or randomly distributed and compacted in place to create a moisture barrier from water intrusion from above or below.

The present invention relates specifically to systems and methods for re-purposing discarded asphalt shingles (also referred to as “DAS”) as fill material beneath land surface construction (referred to as “LSC”) including building foundations, roadways, landscaping, parking lots, and embankments. The present invention further relates to systems and methods for re-purposing DAS in block form (also referred to herein as “RAB” or repurposed asphalt block) to be used as structural members in below and above ground constructions including retaining walls, dams, levies, berms, harbors, and the like.

Forming DAS material into discrete building blocks facilitates the handling and transport of the material. Various methods may be used to bind stacked and cross-oriented layers of the DAS material into various sized blocks that may be positioned within excavations and used as forms for concrete slabs and the like.

### BRIEF DESCRIPTION OF THE DRAWINGS

FIG. 1 is a cutaway profile view of an implementation of a first preferred embodiment of the systems and methods of the present invention in connection with the soils beneath a slab building foundation.

FIG. 2 is a cutaway plan view of the implementation of the systems and methods of the present invention shown in FIG. 1 taken along the Section Line referenced in FIG. 1 as “Fig. 2”.

FIG. 3 is a cutaway plan view of the implementation of the systems and methods of the present invention shown in FIG. 1 taken along the Section Line referenced in FIG. 1 as “Fig. 3”.

FIG. 4 is a perspective view of a representative example of a single constructed building block of the systems and methods of the present invention shown used in FIG. 1.

FIG. 5 is a cross-section view of the representative example of a single constructed building block of the system of the present invention shown in FIG. 4, viewed along Section Line A-A′.

FIG. 6 is a cutaway view of an implementation of a second preferred embodiment of the systems and methods of the present invention in connection with the soils beneath a slab building foundation.

FIG. 7 is a cutaway view of an implementation of a third preferred embodiment of the systems and methods of the present invention in connection with the soils beneath a surface construction (such as a paved parking lot).

FIG. 8 is a top plan view of the implementation of the third preferred embodiment of the systems and methods of the present invention as shown in FIG. 7, in connection with the stabilization of soils beneath a surface construction (such as a paved parking lot), with perimeter fill removed for clarity.

FIG. 9 is a cutaway profile view of an implementation of an exemplary embodiment of the systems and methods of the present invention in connection with a conventional retaining wall.

FIG. 10 is a cutaway profile view of an implementation of an exemplary embodiment of the systems and methods of the present invention in connection with a segmental retaining wall.

FIG. 11 is a schematic side view of an implementation of an exemplary embodiment of the systems and methods of the present invention as ballast for temporary or added structure installations.

FIG. 12 is a cutaway profile view of an implementation of an exemplary embodiment of the systems and methods of the present invention in connection with a moisture barrier around foundations or structures.

FIG. 13 is a cutaway profile view of an implementation of an exemplary embodiment of the systems and methods of the present invention in connection with a weed barrier in landscapes.

FIG. 14 is a cutaway profile view of an implementation of an exemplary embodiment of the systems and methods of the present invention used as a soil stabilizer or backfill for embankments.

FIG. 15 is a cutaway profile view of an implementation of an exemplary embodiment of the systems and methods of the present invention used as backfill for civil infrastructure type projects.

FIG. 16 is a cutaway profile view of an implementation of an exemplary embodiment of the systems and methods of the present invention with block and backfill components used in connection with a segmental retaining wall.

FIG. 17 is a cutaway profile view of an implementation of an exemplary embodiment of the systems and methods of the present invention in connection with a water dam embankment.

### DETAILED DESCRIPTION OF THE EXEMPLARY EMBODIMENTS

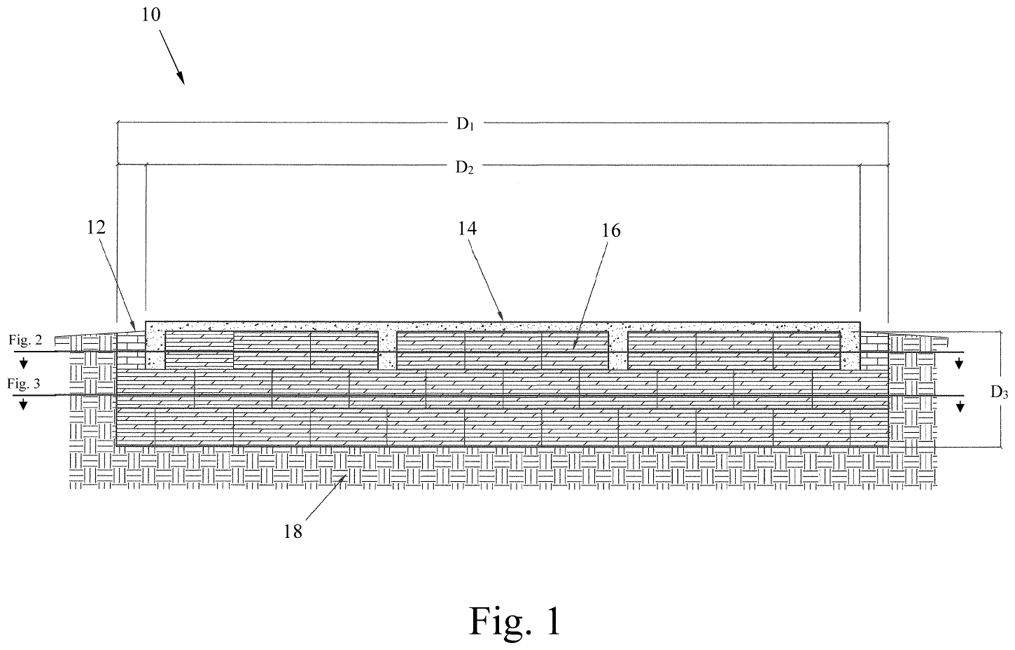

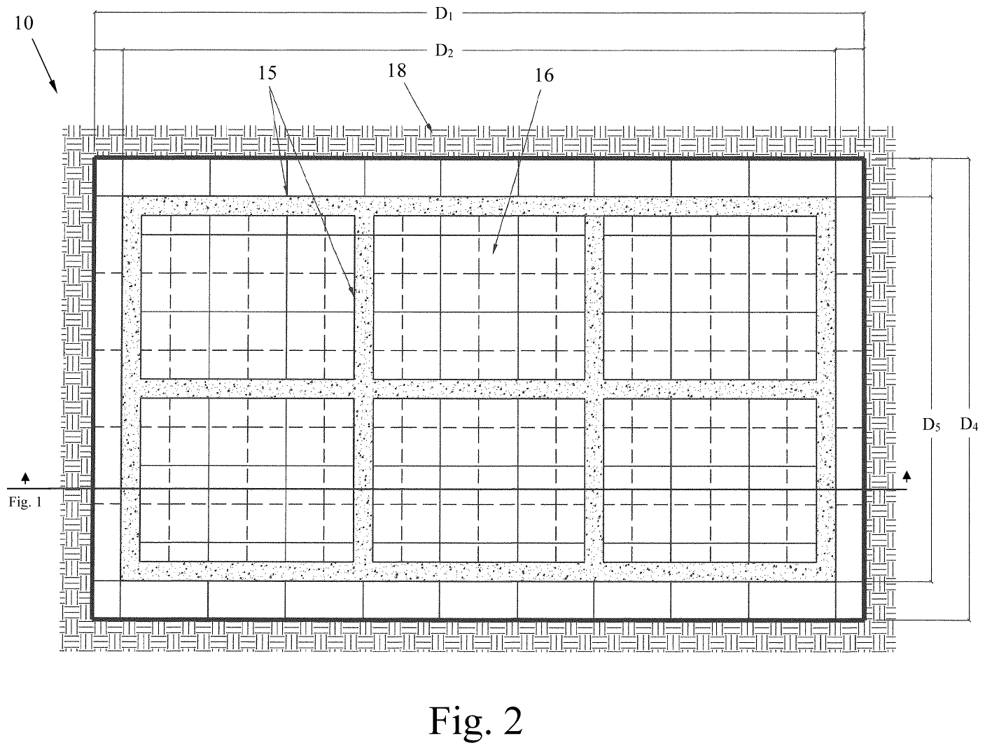

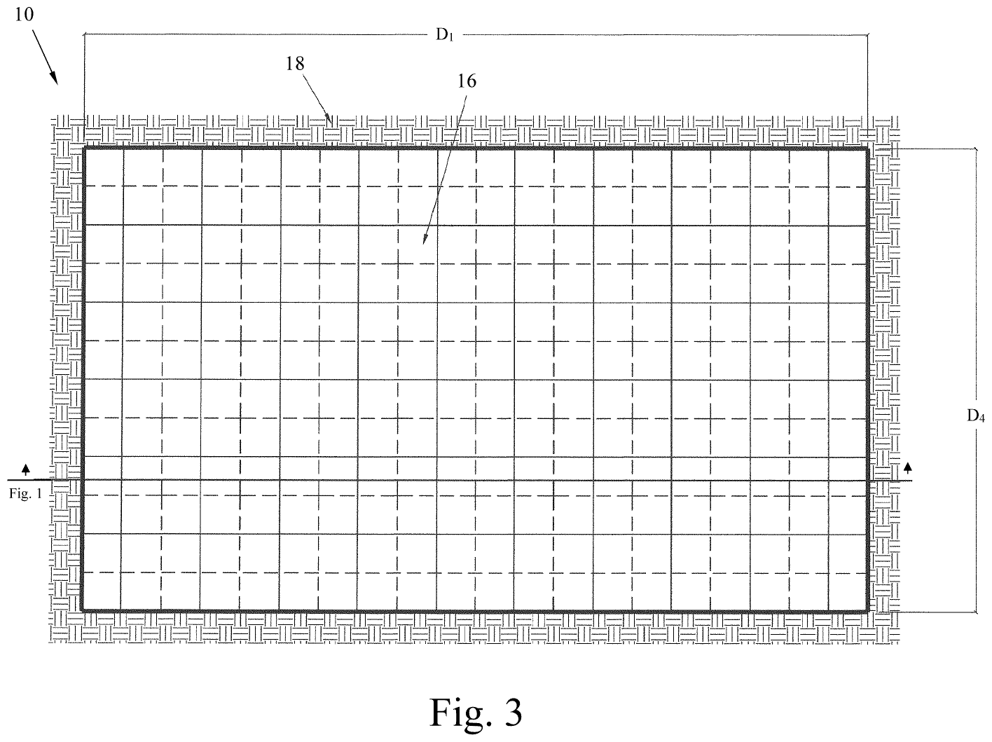

Reference is made first to FIG. 1 which is a cutaway profile view of an implementation of a first preferred embodiment of the systems and methods of the present invention in connection with the stabilization of soils beneath a slab building foundation. In this implementation, preformed building block system (BBS) units are used beneath a reinforced concrete foundation . As shown in FIG. 1, fill system 10 is generally constructed within an excavation made into in-situ soil 18 having typical length dimension D₁, width dimension D₄ (see FIG. 2), and depth dimension D₃. A typical example as shown might be constructed with D₁=40 feet; D₄=24feet; and D₃=6 feet.

Fill system 10 is constructed with an array of building block system (BBS) units 16 positioned and stacked in staggered layers within the excavation in the manner shown, with reinforced concrete slab and beams 14 formed over the BBS units 16. In the preferred embodiment, the concrete slab foundation can be incrementally smaller than the BBS unit filled excavation having a foundation length dimension D₂ (37 feet typical within a 40 foot long excavation); a foundation width dimension D₅ (20 feet typical within a 24 foot wide excavation); and a foundation depth dimension of 2-3 feet (typical). It is preferable to have clay backfill 12 around the perimeter of the slab on top of the lower layers of BBS units 16.

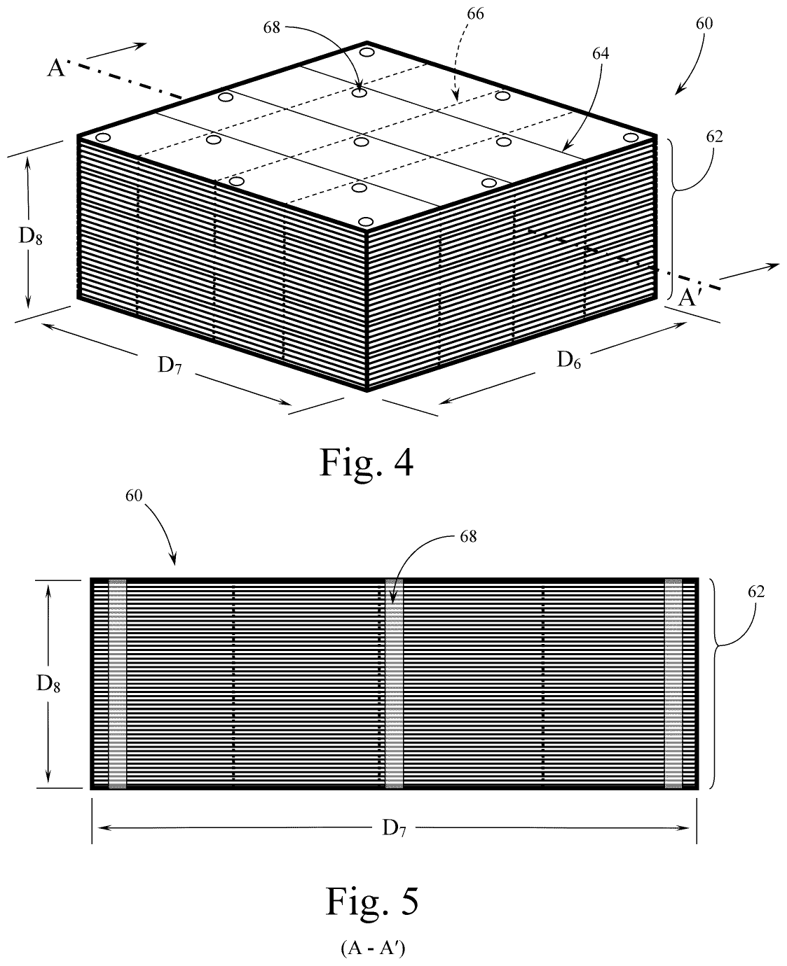

The BBS units 16 shown in FIG. 1 are nominally 4 foot×4 foot×2 foot (see FIGS. 4 & 5 for details) but could be constructed of any dimensions that might be easily handled (with forklifts, for example) and shipped (on flatbed trucks, for example). BBS units sized as 4 foot×2 foot×2 foot might be used in conjunction with the 4 foot×4 foot×2 foot units to fill out the dimensions of a specific installation. Other unit sizes and other combinations of variously sized BBS units are anticipated.

FIG. 2 is a cutaway plan view of the implementation of the systems and methods of the present invention shown in FIG. 1 taken along the Section Line referenced in FIG. 1 as “Fig. 2”. In this view, fill system 10 is again shown to be generally constructed within an excavation made into in-situ soil 18 having typical length dimension D₁, width dimension D₄, and depth dimension D₃(see FIG. 1). Once again, a typical example as shown might be constructed with D₁=40 feet; D₄=24 feet; and D₃=6 feet.

Fill system 10 is again shown to be constructed with an array of building block system (BBS) units 16 positioned and stacked in staggered layers within the excavation in the manner shown. Solid lines for the BBS units 16 represent a first, visible layer, while broken lines for the BBS units 16 represent a staggered lower layer. The staggered layers, of course, improve overall stability and reduce or eliminate vertical shifting. In FIG. 2, reinforced concrete beams 15 are formed over and around the BBS units 16.

In the preferred embodiment, the concrete slab foundation should be incrementally smaller than the BBS unit filled excavation having a foundation length dimension D₂ (37 feet typical within a 40 foot long excavation) and a foundation width dimension D₅ (20 feet typical within a 24 foot wide excavation).

FIG. 3 is a cutaway plan view of the implementation of the systems and methods of the present invention shown in FIG. 1 taken along the Section Line referenced in FIG. 1 as “Fig. 3”. In this view, a plan view below the concrete slab, only the stacked and staggered BBS units 16 are seen in the in-situ soil 18 excavation. Once again, solid lines for the BBS units 16 represent a first, visible layer, while broken lines for the BBS units 16 represent a staggered lower layer.

In a preferred method of constructing the system 10 shown in FIGS. 1-3, an excavation of the required dimensions (refined to be equal to a multiple of the available sized BBS units) is made. The excavation is then filled with the lower staggered layers of BBS units that will sit below the entire concrete foundation. BBS units are then arranged in groups on top of the lower layers in a manner that defines the concrete beams to be formed. The BBS units are sufficiently heavy as to remain in place as the reinforced concrete slab and beams are poured and formed. The perimeter edge may be confined using standard foundation wall forms that are removed after curing and then back filled with clay as shown in FIG. 1.

Reference is now made to FIGS. 4 & 5 for a description of the structures and methods of manufacturing an individual BBS unit of the type utilized in the first embodiment shown in FIGS. 1-3 above. FIG. 4 is a perspective view of a representative example of a single constructed building block of the systems and methods of the present invention shown used in FIG. 1. Building block system (BBS) unit 60 is generally made up of asphaltic shingle layers 62, which may include whole, partially degraded, or even smaller pieces of typical used and discarded roofing shingles. Preferably the whole or nearly whole shingles are stacked parallel to each other in a single layer and oriented orthogonally to the layers beneath and above the specific layer. In this manner, the assembled block can be bound together in a very strong layered bundle. In FIG. 4, a top layer 64 of shingles (solid lines) is oriented in a first direction while a second layer 66 of shingles (broken lines) is oriented orthogonal to the first layer.

Various methods of binding the layers may be employed in the production of the BBS units. In FIG. 4, a “hot stab” method is shown wherein a heated rod is driven through the layers of shingles at various points, being directed from one face of the block to the opposite face. In the process of moving through the layers the heated rod melts the adjacent portions of the shingles through which it passes, melting the walls of the produced shaft 68 and thereby binding the layers together. Other methods for binding the BBS unit together include: (a) using mechanical attachment devices (bolts, screws, rivets, etc.) that are passed through the layers and bound on either end; (b) screws that penetrate one layer and two or three adjacent layers, building a bound block as the shingles are layered on; (c) high pressure that forces the pliable asphaltic material together (with or without heat); (d) high temperature that melts the layers together (with or without pressure); (e) adhesives placed between the layers (with or without pressure); (f) wrapping of the entire bundle with polymer plastic sheeting; (g) strapping the bundle with plastic or metal straps, cords, or wires; (h) heated rods (described above with FIGS. 4 & 5); (i) drilling shafts to mechanically disrupt each layer in a manner that holds one layer to the next (with or without heat); or (j) a combination of the above methods.

The dimensions of a single BBS unit can vary significantly but the preferred dimensions start with the basic dimensions of the more common roof shingles. Although asphaltic roof shingles come in many shapes and sizes a traditional design comprises a 12 inch by 36 inch three tab design. Discarded shingles often break along a tab which results in discarded shingles most often being 12×36; 12×24; or 12×12 (inches in each case). Such pieces lend themselves to being assembled in layers that are 4 feet by 4 feet; 3 feet by 3 feet; 2 feet by 4 feet; 2 feet by 3 feet; etc. The larger the BBS unit the fewer discrete blocks that are required for a given construction. The factors that ultimately limit the preferable dimensions of a BBS unit are handling and transport limitations. The embodiment shown in FIGS. 4 & 5 provides a dimension balance between making the block as large as possible while still being readily handled by standard construction equipment such as forklifts and cranes. In FIGS. 4 & 5, BBS unit 60 may preferably have dimension D₆ equal to 4 feet; dimension D₇ equal to 4 feet; and dimension D₈ equal to 2 feet.

FIG. 5 is a cross-section view of the representative example of a single constructed building block of the system of the present invention shown in FIG. 4, viewed along Section Line A-A′. In this view, heated rod produced shafts 68 are positioned in a spaced array that solidly binds the shingle layers 62 together. Such binding is sufficient to allow for the rough handling of the produced block without the layers separating. As described above, other methods for adequately binding the layers together are anticipated.

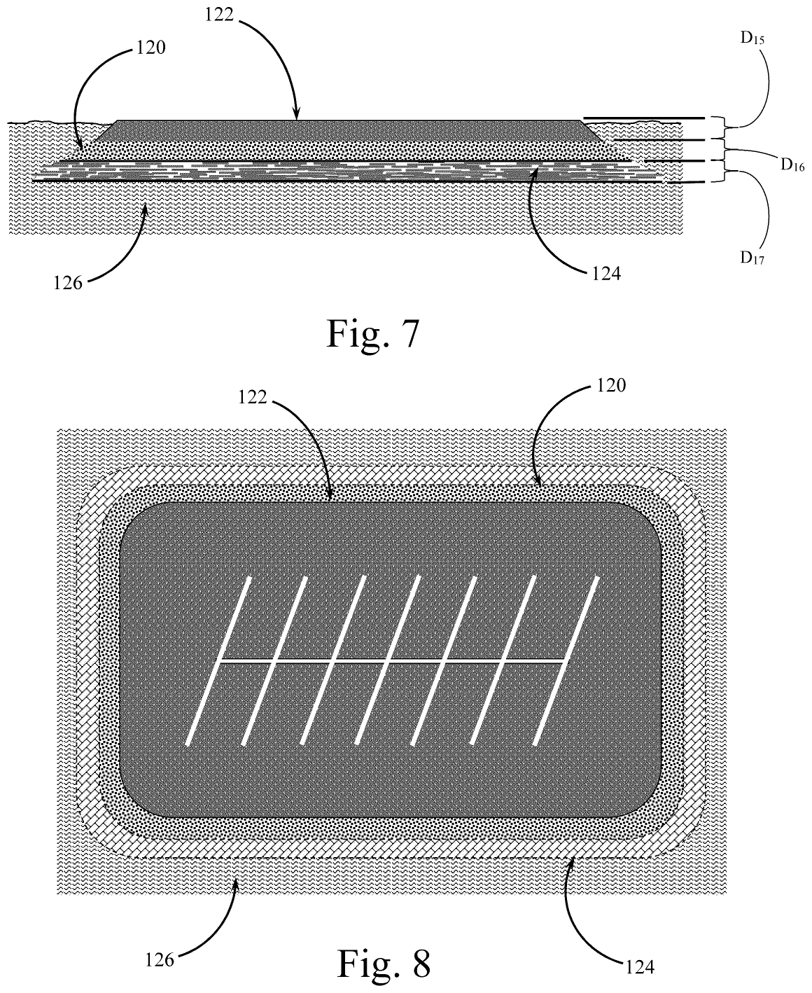

FIG. 7 is a cutaway view of an implementation of a third preferred embodiment of the systems and methods of the present invention in connection with the stabilization of soils beneath a surface construction (such as a paved parking lot).

FIG. 8 is a top plan view of the implementation of the third preferred embodiment of the systems and methods of the present invention as shown in FIG. 7, in connection with the stabilization of soils beneath a surface construction (such as a paved parking lot), with perimeter fill removed for clarity.

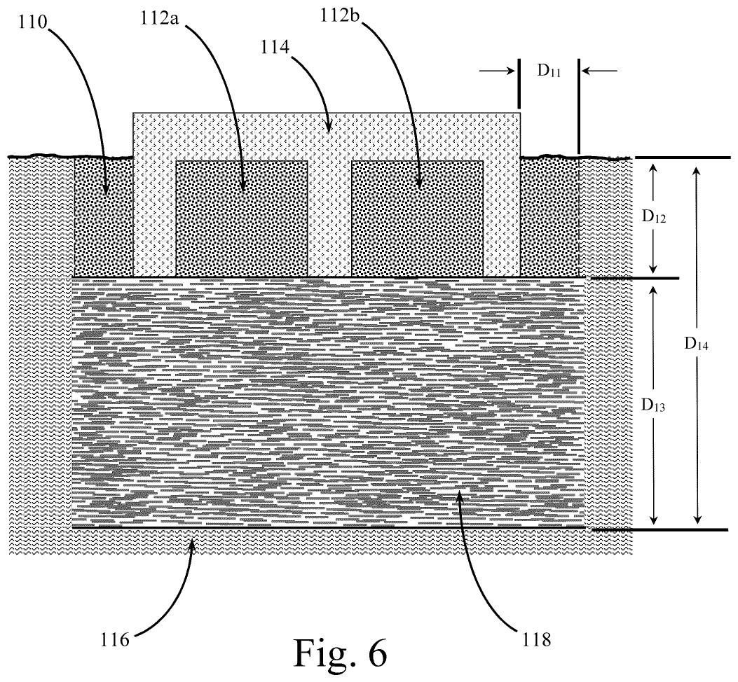

Reference is made next to FIG. 6 which shows a profile cutaway view of an implementation of a second preferred embodiment of the systems and methods of the present invention in connection with the stabilization of soils beneath a slab building foundation. In the example shown, monolithic slab 114 is shown with select fill 110 around the slab and select fill 112a & 112b beneath the floor portion of the slab within the beam walls of the slab. This arrangement is typical in modern construction techniques and is similar to the arrangement described above with FIG. 1. Typical modern building techniques would also include expensive select fill below the entire foundation in place of removed expansive soils (swelling clay) to reduce upheaval with water intrusion. Alternately, the expansive soils might be treated with expensive soil stabilizers to reduce upheaval.

The alternate embodiment of the present invention shown in FIG. 6 provides layered discarded asphalt shingles in place of a quantity of excavated soil as the initial step in the process of preparing the site for the foundation. A volume of the in-situ soil 116 is removed and replaced with layers of discarded asphalt shingles (DAS) 118 on top of the in-situ soil 116 remaining.

In the example shown, there is a typical distance D₁₁ of three feet around the perimeter of the slab 114 that is filled to grade level with select fill 110. The typical depth D₁₂ of the foundation slab 114 below grade may be two to six feet. In the present invention, a quantity of discarded asphalt shingles 118 is positioned beneath the foundation slab 114 and the perimeter select fill 110. The depth D₁₃ of the DAS 118 may in a preferred embodiment, be anywhere from four to ten feet. This depth may be greater if the size (mass) of the building warrants it or less if the structure is smaller. Overall, an excavation depth of D₁₄ in the range of six to sixteen feet would be typical for implementation of the systems and methods of the present invention.

Reference is finally made to FIGS. 7 & 8 which show a typical implementation of the systems and methods of the present invention in connection with the stabilization of soils beneath a surface construction such as a paved parking lot. FIG. 7 shows a profile cutaway view and FIG. 8 shows a top plan view of a representative paved parking area.

In FIG. 7 in-situ soil 126 is shown excavated and replaced first with a layer of discarded asphalt shingles (DAS) 124, followed by a layer of select fill (SF) 120, and topped with a layer of asphalt paving 122. The typical thickness D₁₅ of asphalt paving layer 122 may preferably be in the four to six inches range. The typical thickness D₁₆ of select fill layer 120 may preferably be in the six to eight inches range. The typical thickness D₁₇ of discarded asphalt shingles layer 124 may preferably be in the six to ten inches range.

FIG. 8 is a top plan view of the parking surface construction shown in FIG. 7 with perimeter soil removed to show the wider lower layers. In the preferred embodiment, the select fill layer 120 extends beyond the perimeter of the asphalt paving layer 122 by one to two feet or more. Similarly, the discarded asphalt shingles layer 124 extends beyond the perimeter of the select fill layer 120 by one to two feet or more. In this manner, upheaval around the edges of the pavement is reduced or eliminated.

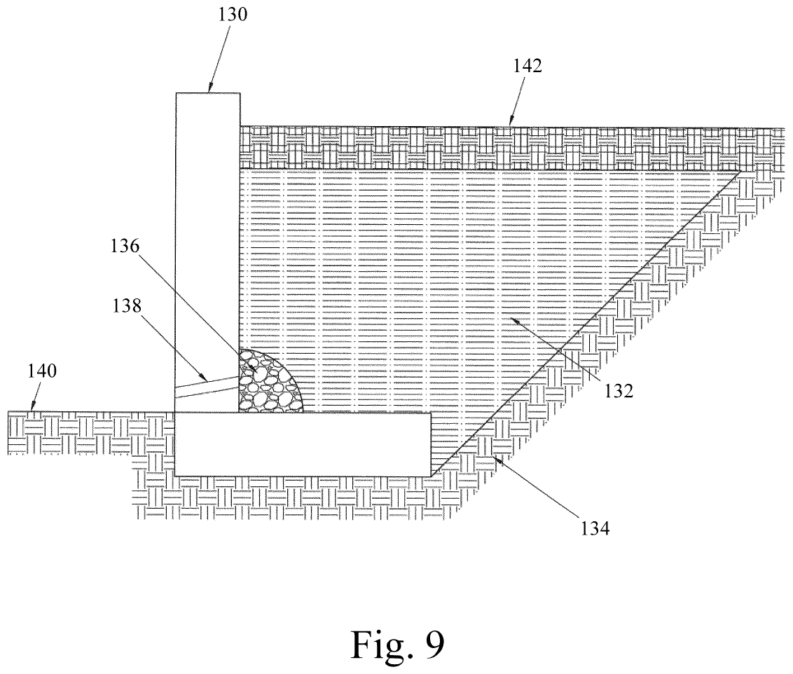

Reference is next made to FIGS. 9-17 for detailed descriptions of various additional exemplary embodiments of the systems and methods of the present invention as applied in different landscaping and construction configurations and environments.

FIG. 9 is a cutaway profile view of an implementation of an exemplary embodiment of the systems and methods of the present invention in connection with a conventional retaining wall. Concrete retaining wall and footing 130 is shown constructed on in-situ soil 134. PVC drainage pipe 138 as is typical for such retaining walls, is shown near the base of retaining wall 130 just above finished grade 140. Behind retaining wall 130, adjacent PVC drainage pipe 138, is washed gravel drainage field 136, again as typical with such retaining walls.

The systems and methods of the present invention are incorporated into this conventional retaining wall construction through the use of backfill 132 composed of loose or RAB formed asphaltic shingles. Completion of the retaining wall construction is made using finished grade 142 typically made up of 8-10 inches of soil or pavement.

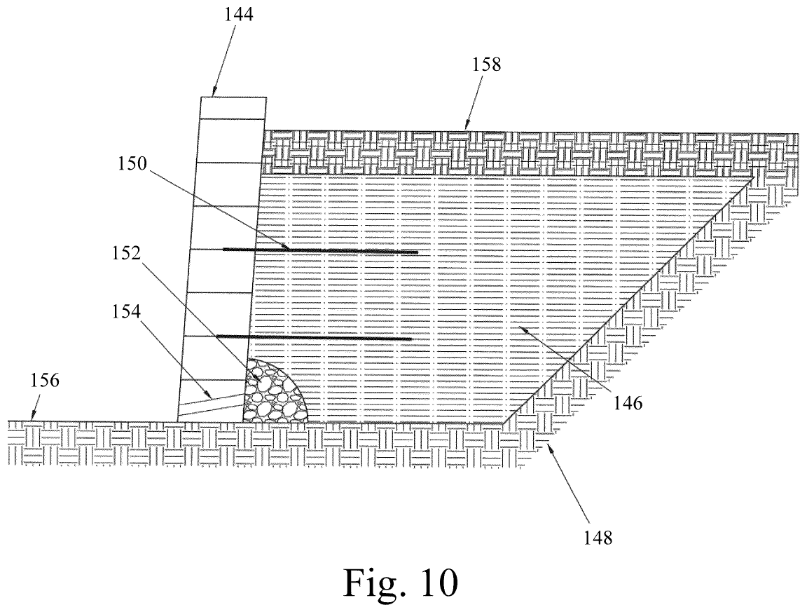

FIG. 10 is a cutaway profile view of an implementation of an exemplary embodiment of the systems and methods of the present invention in connection with a segmental retaining wall. In FIG. 10, concrete segmental retaining wall 144 is shown constructed on in-situ soil 148. As above, PVC drainage pipe 154, typical for such segmental retaining walls, is shown near the base of retaining wall 144 just above finished grade 156. Behind retaining wall 144, adjacent PVC drainage pipe 154, is washed gravel drainage field 152, again as typical with such segmental retaining wall constructions. Incorporated into the construction of the segmental retaining wall 144 are one or more geo-grid reinforcement members 150 as may be required or suggested by the design structure. Backfill 146, again comprised of loose or RAB formed asphaltic shingles according to the systems and methods of the present invention, is integrated into reinforcement members 150 in this embodiment as shown. Completion of the segmental retaining wall construction is made using finished grade 158, again typically made up of 8-10 inches of soil or pavement.

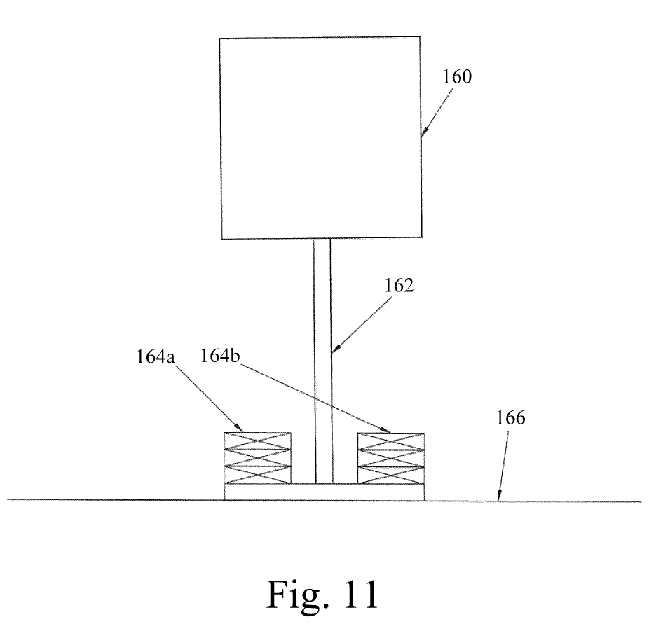

FIG. 11 is a schematic side view of an implementation of an exemplary embodiment of the systems and methods of the present invention as ballast for temporary or added structure installations. In this embodiment, RAB formed asphaltic shingles 164 are shown being used as ballast to stabilize or counterbalance new structures or equipment on top of various structural surfaces. Optimally, this application occurs on flat or nearly flat surfaces including a finished grade or roof-type structure 166. The object 160 being stabilized might include a sign, antenna or other new structure added to an existing structure or on ground level. Ancillary structural object 160 might preferably include support frame 162 such a post or pole for a sign, antenna, or the like. The preferable arrangement is for ancillary structural object 160 to have a base onto which RAB formed asphaltic shingles 164 may be positioned, stacked, and optionally secured. In many cases RAB asphaltic blocks 164 may simply provide stability by weight and resist displacement by friction between the blocks. In other cases, various tie down or immobilizing structures may be utilized.

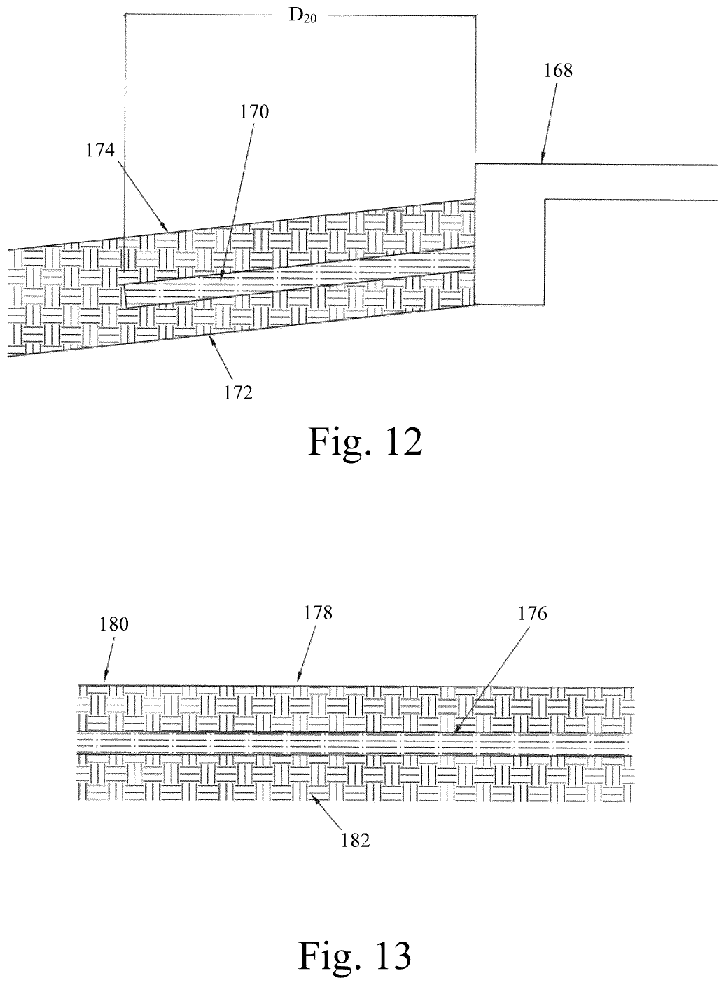

FIG. 12 is a cutaway profile view of an implementation of an exemplary embodiment of the systems and methods of the present invention in connection with a moisture barrier around foundations or other building structures. Foundation or building structure 168 is shown positioned on and/or in the ground adjacent a quantity of in-situ soil 172. A 2-4 inch layer of loose or RAB formed asphaltic shingles 170 are positioned in a continuous layer around the entire foundation or building structure 168. This surrounding construction is completed using finishing grade 174 typically made up of 8-10 inches of soil.

FIG. 13 is a cutaway profile view of an implementation of an exemplary embodiment of the systems and methods of the present invention in connection with a weed barrier in landscapes. Similar in many respects to the configuration shown in FIG. 12, the weed barrier shown in FIG. 13 comprises a 2-4 inch layer of loose or RAB formed asphaltic shingles 176 positioned on top of in-situ soil 182. On top of weed barrier 176 would typically be 8-10 inches of topsoil 178 (or as required) to provide finished grade 180 which may for example be a planting area or other confined area of dedicated soil use.

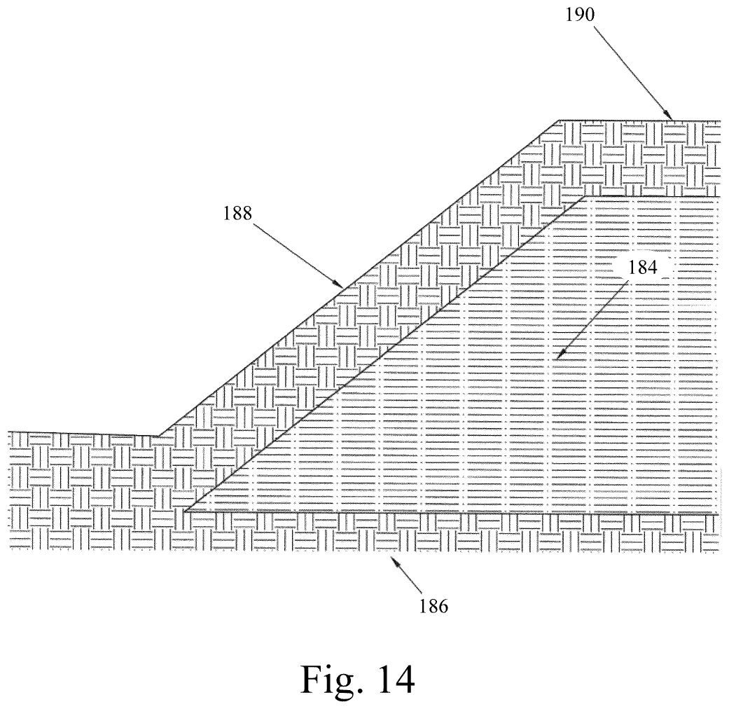

FIG. 14 is a cutaway profile view of an implementation of an exemplary embodiment of the systems and methods of the present invention used as a soil stabilizer or backfill for embankments. In this embodiment, a quantity of loose or RAB formed asphaltic shingles 184 are simply stacked and shaped to form an embankment configuration of the type shown. This shaped embankment 184 may be constructed on in-situ soil 186 as shown before a finishing grade 188 is used to cover the embankment. Once again, finished grade 188 might preferably comprise 8-10 inches of soil, the same or similar to in-situ soil 186. At the top of embankment 184 it may be preferable to provide a finishing grade 190 made up of a roadway, a sidewalk, or other surface construction as an alternative to an additional area layer of 8-10 inches of soil.

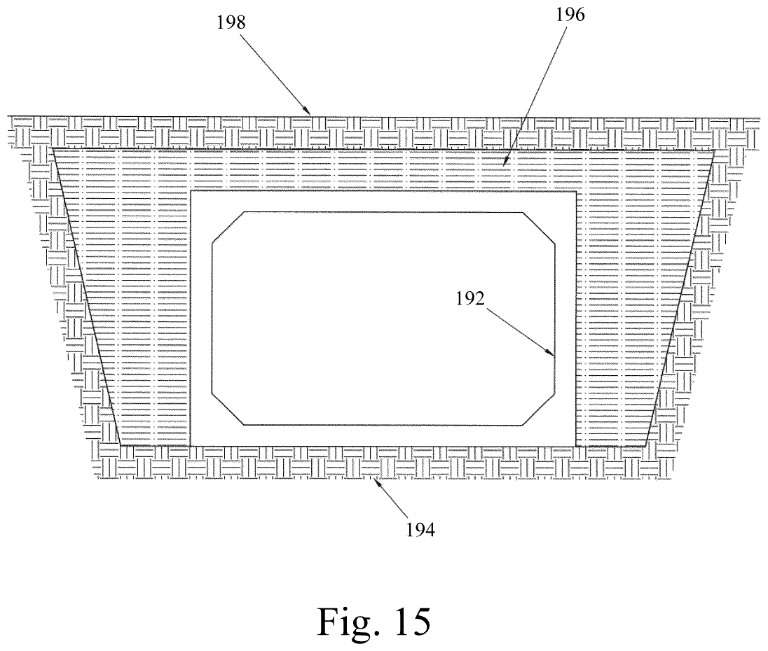

FIG. 15 is a cutaway profile view of an implementation of an exemplary embodiment of the systems and methods of the present invention used as backfill for civil infrastructure type projects. In this embodiment, the materials of the present invention may be used as backfill and/or base material for civil, commercial, and residential projects, involving both below and above grade constructions, such as box culverts, pipes, manholes, dams, levees, berms, roadways, harbors, and other such infrastructure features. In FIG. 15, concrete box culvert 192 (as a typical example of a civil infrastructure feature) is positioned on in-situ soil layer 194, typically within an excavated area to be buried. This recessed volume is then filled with loose or RAB formed asphaltic shingles 196 to surround and cover concrete box culvert 192. The entire construction is then covered over with finished grade 198, typically a roadway surface, a sidewalk, or as described above, with 8-10 inches of soil.

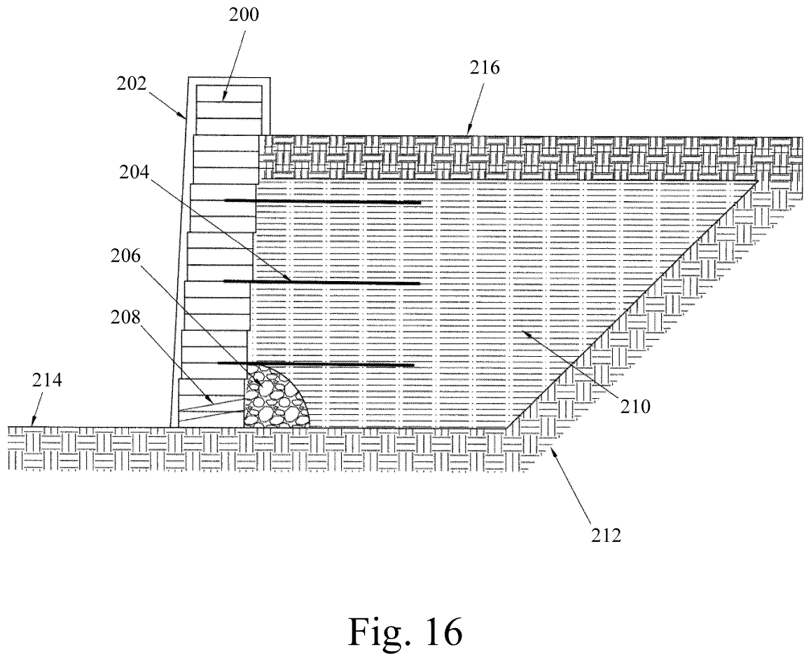

FIG. 16 is a cutaway profile view of an implementation of an exemplary embodiment of the systems and methods of the present invention with block and backfill components used in connection with a segmental retaining wall. The embodiment shown in FIG. 16 is similar in many respects to the embodiment shown in FIG. 10 and described above. The difference between these applications of the systems and methods of the present invention is the utilization of RAB formed asphaltic shingle blocks to construct the segmental retaining wall itself. In FIG. 16, RAB formed asphaltic shingles segmental retaining wall 200 is shown constructed on in-situ soil 212. A layer of plaster or stucco 202 may preferably be placed on the exterior surface of the RAB segmental retaining wall 200 to complete the structure. As above, PVC drainage pipe 208, typical for such segmental retaining walls, is shown near the base of retaining wall 200 just above finished grade 214. Behind retaining wall 200, adjacent PVC drainage pipe 208, is washed gravel drainage field 206, again as typical with such segmental retaining wall constructions. Incorporated into the construction of the RAB segmental retaining wall 200 are one or more geo-grid reinforcement members 204 as may be required or suggested by the design structure. Backfill 210, again comprised of loose or RAB formed asphaltic shingles according to the systems and methods of the present invention, is again integrated into reinforcement members 204 in this embodiment as shown. Completion of the RAB segmental retaining wall construction is made using finished grade 216, again typically 8-10 inches of soil or pavement.

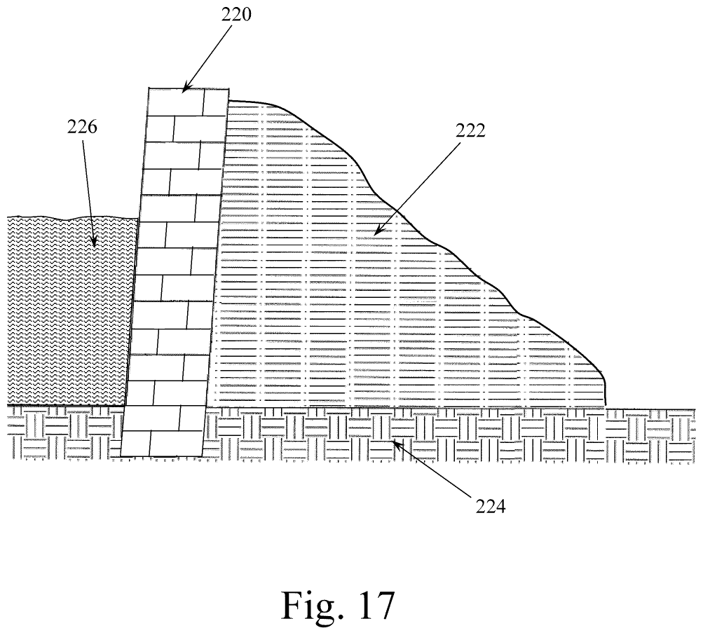

Reference is finally made to FIG. 17 which is a cutaway profile view of an implementation of an exemplary embodiment of the systems and methods of the present invention in connection with a water dam embankment. Similar in some respects to the retaining wall construction shown in FIG. 16, the dam embankment shown in FIG. 17 is centered on construction of an RAB formed asphaltic shingle dam wall 220 formed above and below native ground surface 224. Dam embankment or dam wall 220 may be any of several vertically constructed wall structures typical of small to medium scale dams. One side of RAB block dam wall 220, on top of native ground surface 224, is backfilled with compacted or RAB formed asphaltic shingles 222 as shown. This dam embankment construction is, of course, intended to maintain a body of water 226 on the opposing side of the dam wall 220. Various spillways, locks, and other constructions typical of dam embankments may be incorporated into the structure utilizing various configurations of the RAB materials.

Although the present invention has been described in conjunction with a number of preferred embodiments, those skilled in the art will recognize modifications to these embodiments that still fall within the scope of the present invention. Concrete driveways, sidewalks, and other surface structures fall somewhere between a paved parking area and a building slab foundation and could also benefit from the systems and methods of the present invention. In general, the goal is to provide a “ground shadow” of a moisture barrier that replaces and/or separates the constructed surface or foundation from the expansive soils that would otherwise swell with moisture and buckle or crack the construction. Essentially, any formed construction that rest on or in expansive soils could benefit from the systems and methods of the present invention. Swimming pools, concrete culverts, buried concrete drains, concrete septic tanks, etc. could all benefit from the application of the present invention. The present invention finds application in association with pre-cast or poured in place structures.

We claim:

1. A method for stabilizing in-situ soils around and beneath a rigid structure constructed on and/or within the in-situ soils, the method comprising the steps of:
excavating and shaping a quantity of in-situ soil to establish a surface and/or below grade space for layered construction;
constructing the rigid structure on and/or within the surface and/or below grade space;
recovering a quantity of discarded and/or degraded asphalt shingles of the type typically removed as old roofing material;
layering the quantity of discarded and/or degraded asphalt shingles on top of the surface and/or within the below grade space excavated and shaped in the in-situ soils;
forming and arranging the asphalt shingles in stacked parallel layers above the surface and/or within the below grade excavated space; and
positioning a quantity of finishing material over the stacked parallel layers of asphalt shingles;
wherein the rigid structure and the finishing material are vertically and horizontally supported by the asphalt shingles and therefore are not in direct contact with the in-situ soils that might swell or shift when infiltrated with moisture.
